(19) United States
(12) Patent Application Publication
(10) Pub. No.: US 2026/0336827 A1
(43) Pub. Date: Oct. 29, 2026

(54) WIND DETECTION SYSTEM AND UNMANNED AERIAL VEHICLE

(71) Applicant: Kubota Corporation, Osaka-shi, Osaka (JP)

(72) Inventor: Kohei SEINO, Sakai-shi (JP)

(21) Appl. No.: 19/248,023

(22) Filed: Jun. 24, 2025

Related U.S. Application Data
(63) Continuation of application No. PCT/JP2022/048165, filed on Dec. 27, 2022.

(51) Int. Cl. B64D 47/00; B05B 12/00; B64U 101/40; G01P 13/04

(52) U.S. Cl. CPC B64D 47/00; B05B 12/004; G01P 13/045; B64U 2101/40

(57) ABSTRACT

A wind detection system includes a sensor to detect a first tilt angle of an unmanned aerial vehicle with respect to a first direction perpendicular to a vertical direction, and a second tilt angle of the unmanned aerial vehicle with respect to a second direction that is perpendicular to the vertical direction and intersects the first direction, and a processor configured or programmed to estimate at least one of wind speed and wind direction based on sensor data output from the sensor indicating the first and second tilt angles.

### CROSS REFERENCE TO RELATED APPLICATIONS

This application is a Continuation Application of PCT Application No. PCT/JP2022/048165 filed on Dec. 27, 2022. The entire contents of this application are hereby incorporated herein by reference.

### BACKGROUND OF THE INVENTION

### 1. Field of the Invention

The present disclosure relates to wind detection systems and unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

In the flight control of unmanned aerial vehicles, it is necessary to know the wind speed and direction in the air from a safety perspective. Additionally, since flight of unmanned aerial vehicles must be restricted when wind speed exceeds limit values, accurate measurement of wind speed in the air is required. Japanese Patent Application Publication No. 2020-153792 describes a technology for estimating wind speed from a function that defines the relationship between the drag force received by the UAV from the wind and the wind speed, based on the thrust generated by the propellers obtained from control signals output from the flight controller and the tilt angle of the unmanned aerial vehicle relative to the horizontal direction.

### SUMMARY OF THE INVENTION

There is a need for improved technology for estimating wind speed and/or direction in the air.

Unmanned aerial vehicles have different sizes depending on the type of vehicle and may have complex shapes.

Example embodiments of the present disclosure provide wind detection systems each capable of estimating wind speed and/or direction in the air regardless of the type, body size, or shape of the unmanned aerial vehicle, and also provide unmanned aerial vehicles including such a wind detection system.

In a non-limiting example embodiment of the present disclosure, an unmanned aerial vehicle includes a plurality of rotors, a sensor to detect a first tilt angle of the unmanned aerial vehicle with respect to a first direction perpendicular to a vertical direction, and a second tilt angle of the unmanned aerial vehicle with respect to a second direction that is perpendicular to the vertical direction and intersects the first direction, and a processor configured or programmed to estimate at least one of wind speed and wind direction based on sensor data output from the sensor indicating the first and second tilt angles.

Example embodiments of the present disclosure provide wind detection systems each capable of estimating wind speed and/or direction in the air regardless of the type, body size, or shape of the unmanned aerial vehicle and unmanned aerial vehicles including such wind detection systems.

The above and other elements, features, steps, characteristics and advantages of the present invention will become more apparent from the following detailed description of the example embodiments with reference to the attached drawings.

### BRIEF DESCRIPTION OF DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3 is a block diagram showing a configuration example where an inertial measurement unit, a processor, a storage, a controller, and a communication device are connected to a bus.

FIG. 4A is a schematic diagram for explaining a first tilt angle of a multicopter with respect to a first direction.

FIG. 4B is a schematic diagram for explaining a second tilt angle of a multicopter with respect to a second direction.

FIG. 5 is a diagram showing an example of a table.

FIG. 6 is a diagram for explaining wind directions.

FIG. 7 is a side view schematically showing one example of a basic configuration of a multicopter including a connector.

FIG. 8A is a schematic diagram showing a multicopter hovering in the air with an object suspended from it.

FIG. 8B is a schematic diagram showing another view of a multicopter hovering in the air with an object suspended from it.

FIG. 9 is a diagram showing an example of a table defining the relationship between a third tilt angle, tension, and wind speed around the object.

FIG. 10 is a schematic diagram showing how the horizontal distance of material spread from a spreader changes according to wind speed.

FIG. 11 is a schematic diagram showing an example where a multicopter, an agricultural machine, a server, and a terminal device are connected via a communication network.

### DETAIL DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

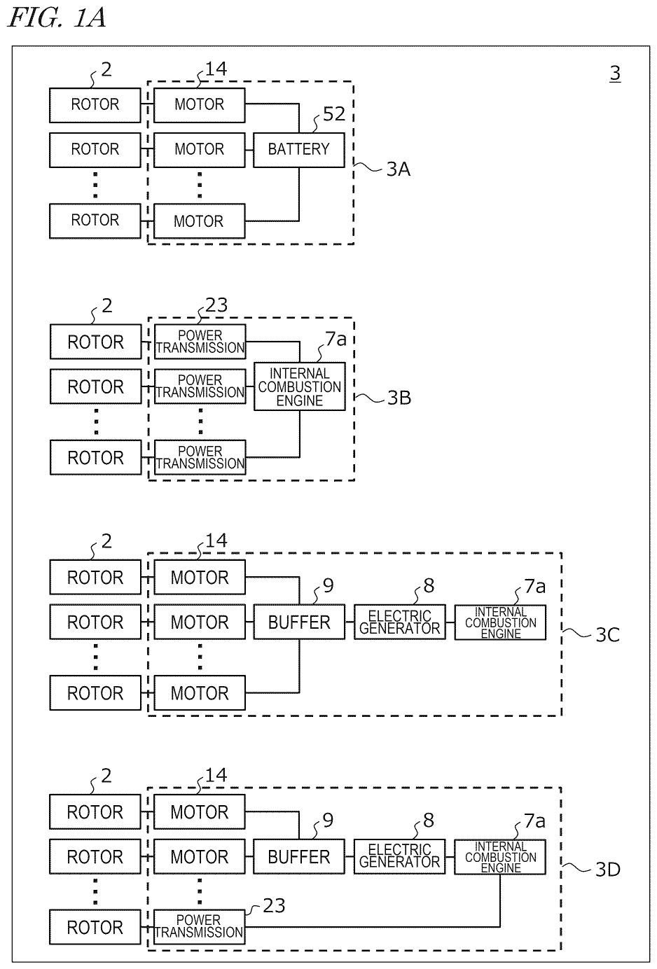

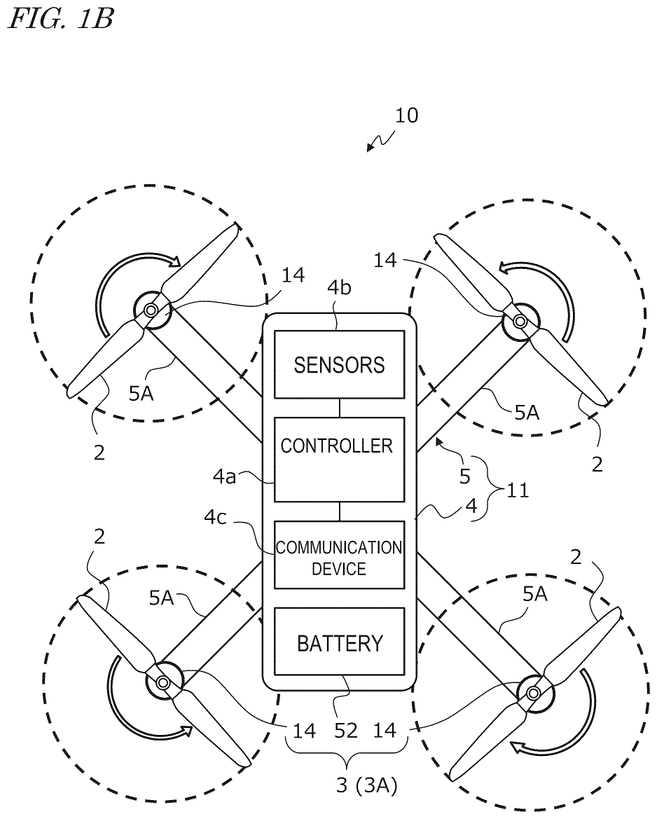

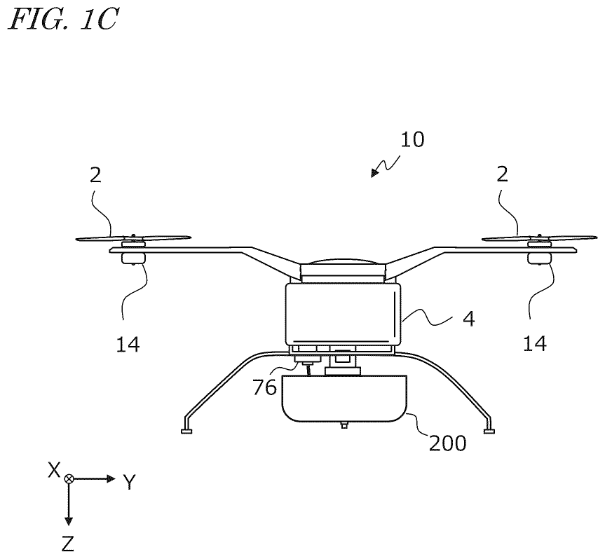

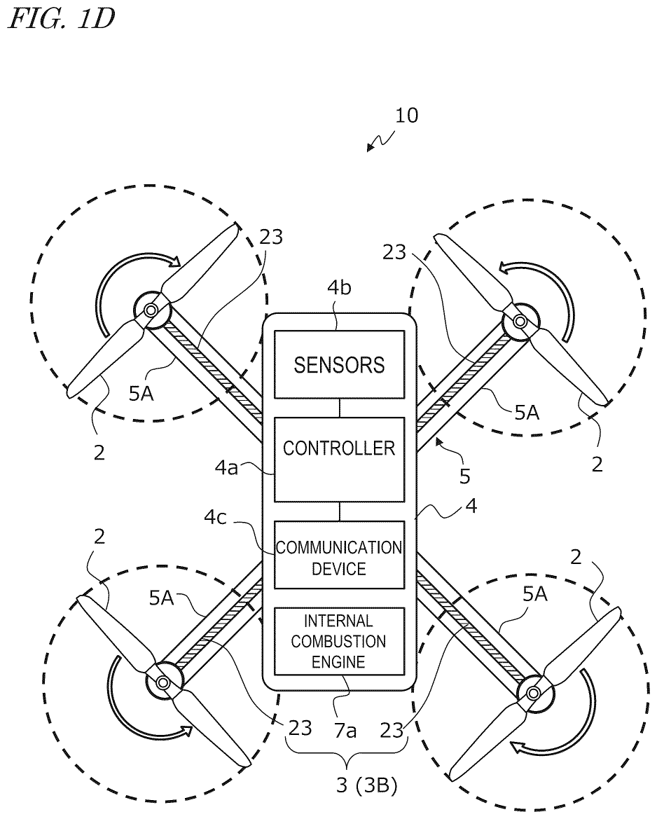

The configuration of rotation drivers included in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, and a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motors 14. In the fourth rotation driver 3D, since mechanical energy generated by internal combustion engine 7a can be utilized for rotor rotation without conversion to electrical energy, energy utilization efficiency can be enhanced. This type of drive is called “parallel hybrid driver”.

FIG. 1B is a plan view schematically showing a basic configuration example of multicopter 10. The configuration example in FIG. 1B includes the first rotation driver 3A shown in FIG. 1A as rotation driver 3. That is, in this example, rotation driver 3 (3A) includes motors 14 and a battery 52. FIG. 1C is a side view schematically showing the multicopter.

The multicopter 10 shown in FIGS. 1B and 1C includes a plurality of rotors 2 a main body 4, and a body frame 5 that supports rotors 2 and main body 4. The body frame 5 supports the main body 4 at its central portion and supports the plurality of rotors 2 rotatably with a plurality of arms 5A extending outward from the central portion. The motors 14 that rotate rotors 2 are provided near the ends of each arm 5A.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, an angular velocity sensor, a geomagnetic sensor, an atmospheric pressure sensor, an altitude sensor, a temperature sensor, a flow sensor, an imaging device, a laser sensor, an ultrasonic sensor, an obstacle contact sensor, and a GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR.

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute some or all of the functions of the companion computer.

A battery 52 is a secondary battery that is configured to store electric power through charging and supply electric power to the motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned more inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used for both generating thrust and attitude control. The main rotors may be called “booster rotors” and the sub-rotors may be called “attitude control rotors”.

In the parallel hybrid driver, the internal combustion engine 7a is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine 7a and uses the internal combustion engine 7a for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of spreading substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may be including mechanisms such as robotic hands. In that case, a single implement 200 can perform various ground operations. Additionally, if the implement 200 includes space large enough to store materials, the implement 200 can also transport agricultural materials or harvested crops over a wide area.

In the example shown in FIG. 1C, the multicopter 10 includes power supply 76. The power supply 76 is a device that supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery for storing power.

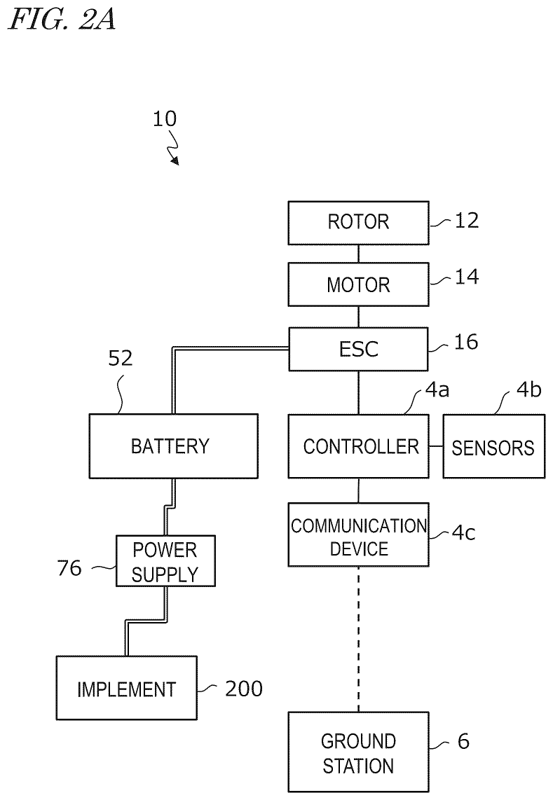

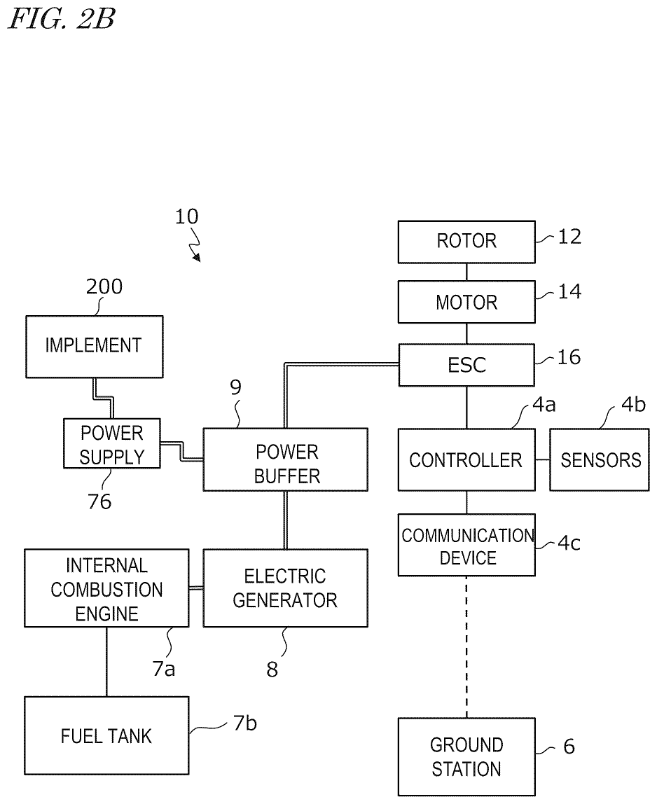

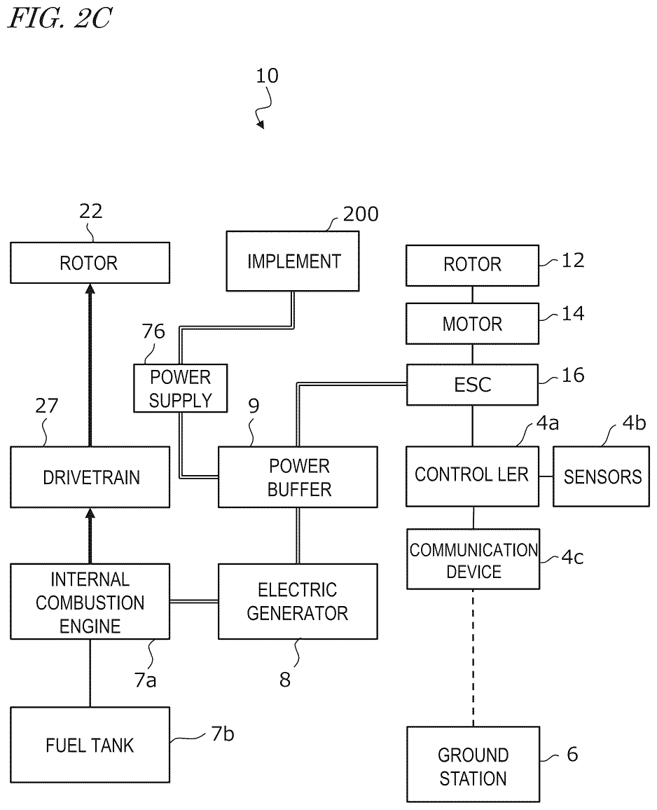

FIG. 2A is a block diagram showing a basic configuration example of a battery-driven multicopter 10. The battery-driven multicopter 10 includes a plurality of rotors 12, a plurality of motors 14 each rotating a respective one of the plurality of rotors 12, a plurality of ESCs (Electric Speed Controllers) 16 each including a motor drive circuit that drives a respective one of the plurality of motors 14, a battery 52 that supplies power to each of the motors 14 through respective ESCs 16, a controller 4a for controlling a plurality of ESCs 16 to control attitude while flying, sensors 4b, a communication device 4c, and a power supply 76 that is electrically connected to the battery 52. Rotor 12 is an example of rotor 2. Devices such as the controller 4a, sensors 4b, communication device 4c, etc., may be connected to each other through a CAN (Controller Area Network) bus to enable communication. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C.

The controller 4a may receive control commands wirelessly from, for example, a ground station 6 on the ground through the communication device 4c. The number of ground stations 6 is not limited to one, and they may be distributed across multiple locations. The communication device 4c may also wirelessly receive control commands from an operator's controller on the ground. The controller 4a may be configured or programmed to perform functions to automatically or autonomously execute takeoff, flight, obstacle avoidance, and landing operations based on sensor data obtained from the sensors 4b.

The controller 4a may be configured or programmed to communicate with the implement 200 connected to power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless means.

FIG. 2B is a block diagram showing a basic configuration example of a series hybrid driver type multicopter 10. Like the battery-driven multicopter 10, the series hybrid driver type multicopter 10 includes a plurality of rotors 12, a plurality of motors 14, a plurality of ESCs 16, a controller 4a, sensors 4b, and a communication device 4c. The series hybrid driver type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid driver type multicopter 10. Like the series hybrid driver type multicopter 10, the parallel hybrid driver type multicopter 10 includes a plurality of rotors 12, a plurality of motors 14, a plurality of ESCs 16, a controller 4a, sensors 4b, a communication device 4c, an internal combustion engine 7a, a fuel tank 7b, an electric generator 8, a power buffer 9, and a power supply 76. The parallel hybrid driver type multicopter 10 further includes a drivetrain 27 that transmits driving force from the internal combustion engine 7a, and rotor 22 that rotates upon the receiving driving force from the internal combustion engine 7a through the drivetrain 27. Rotor 22 is an example of rotor 2. The number of rotors 22 connected to the drivetrain 27 and rotated may be one or two or more.

In the parallel hybrid driver type multicopter 10, the internal combustion engine 7a not only drives the electric generator 8 to generate power but also mechanically transmits energy to rotor 22 to rotate the rotor 22. In contrast, in the series hybrid driver type multicopter 10, all rotors 12 are rotated by electric power generated by the electric generator 8. Therefore, in the series hybrid driver type multicopter 10, if the electric generator 8 is, for example, a fuel cell, then the internal combustion engine 7a is not an essential component.

A wind detection system suitable for use with multicopters is described as follows.

A wind detection system according to an example embodiment of the present disclosure is configured or programmed to estimate at least one of wind speed and wind direction based on the tilt of the multicopter with respect to each of a plurality of directions that intersect each other in the same horizontal plane perpendicular to the vertical direction.

Conventionally, anemometers have been used to measure wind speed. With the increasing frequency of abnormal weather events such as storms and heavy rainfall, there is a demand for measuring weather conditions such as wind speed, wind direction, temperature, and humidity at more ground locations. It is possible to estimate wind speed in the air based on wind speed measured by ground-installed anemometers, but the actual wind speed in the air may differ from such estimated wind speed.

As disclosed in Japanese Patent Application Publication No. 2020-153792, instead of using an anemometer, wind speed can be estimated from a function that defines the relationship between the wind force received by the multicopter and the wind speed. However, as mentioned earlier, there are various types of multicopters, and therefore, the shape of the body can become complex depending on the type or application. Consequently, the wind force received by such a multicopter body differs at the front, rear, left, and right sides. The more complex the body shape becomes, the more difficult it becomes to estimate wind speed based on the tilt of the multicopter with respect to a single horizontal direction. The shape of the body is expected to become increasingly complex in the future, and it is desirable to accurately estimate wind speed and/or direction in the air regardless of the body shape and size.

According to wind detection systems of example embodiments of the present disclosure, even if the body shape becomes complex, wind speed and/or direction can be estimated in real-time based on the tilt of the multicopter with respect to each of a plurality of directions that intersect each other in the same horizontal plane perpendicular to the vertical direction. For example, it is possible to estimate an agrochemical application status of agricultural chemicals dispersed from the air based on wind speed and direction, enabling efficient agrochemical application work by multicopters. Estimation of the agrochemical application status will be described later.

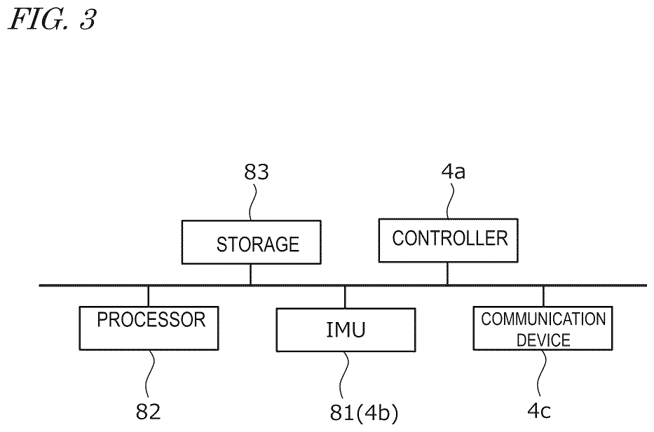

FIG. 3 is a block diagram showing a configuration example where an IMU 81 (4b), a processor 82, a storage 83, a controller 4a, and a communication device 4c are connected to a bus. These devices are connected to each other through, for example, a CAN bus to enable communication.

A wind detection system according to an example embodiment of the present disclosure includes a sensor 81 and a processor 82 configured or programmed to process sensor data output from the sensor 81. For example, the sensor 81 and the processor 82 may be modularized as a wind detection system. Such a module may be manufactured and sold independently of the multicopter and can also be attached later to existing multicopters.

The multicopters according to example embodiments of the present disclosure are not limited to a quad-type multicopter but may be, for example, a hexa-type multicopter (hexacopter) including six rotors, or an octo-type multicopter (octocopter) including eight rotors.

The sensor 81 is configured to detect a first tilt angle of the multicopter with respect to a first direction perpendicular to the vertical direction, and a second tilt angle of the multicopter with respect to a second direction that is perpendicular to the vertical direction and intersects the first direction. The sensor 81 may further be configured to detect a rotation angle of the multicopter around an axis parallel to the vertical direction. Examples of sensor 81 include an IMU, an acceleration sensor, an angular velocity sensor, or a combination of an acceleration sensor and an angular velocity sensor. In example embodiments of the present disclosure, the sensor 81 is an IMU. The IMU functions as a motion sensor and can output signals indicating quantities such as acceleration, velocity, displacement, and attitude of the multicopter.

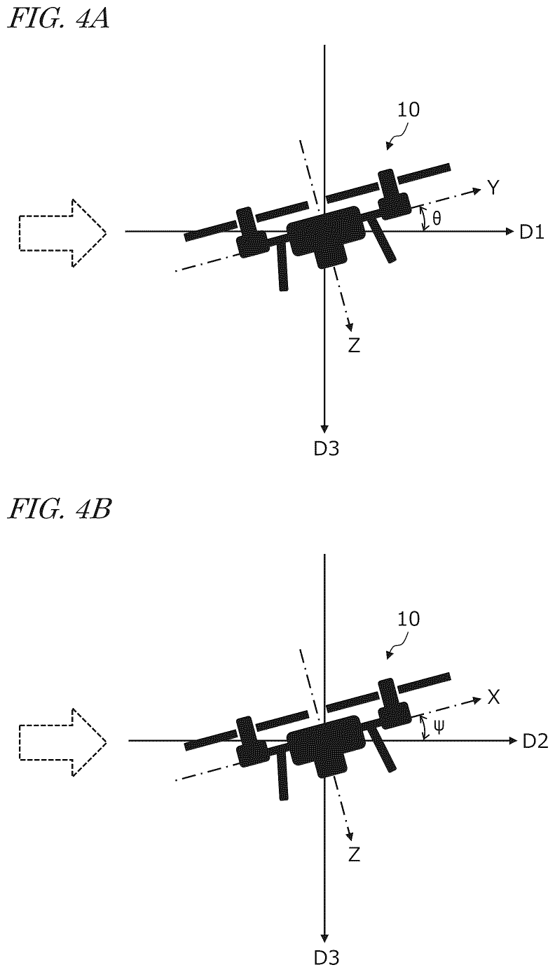

FIG. 4A is a schematic diagram for explaining a first tilt angle θ of multicopter 10 with respect to a first direction D1. FIG. 4B is a schematic diagram for explaining a second tilt angle Ψ of multicopter 10 with respect to a second direction D2. In the examples shown in FIGS. 4A and 4B, the first, second, and third directions D1-D3 are mutually perpendicular. The first and second directions D1, D2 are each horizontal directions, and the third direction D3 is the vertical direction. The first direction D1 is perpendicular to the third direction D3. The second direction D2 is perpendicular to both the first and third directions D1, D3. Thus, the first and second directions D1, D2 are mutually perpendicular in the same horizontal plane perpendicular to the third direction D3. However, the first and second directions D1, D2 need not be perpendicular to each other, as long as they intersect in the same horizontal plane.

FIGS. 4A and 4B show an orthogonal coordinate system with X, Y, and Z axes corresponding to the roll axis, pitch axis, and yaw axis fixed to the multicopter 10. FIGS. 1B, 1C, or 1D shows an example of roll, pitch, and yaw axes fixed to the multicopter 10. Rotation of the multicopter 10 around the X axis is roll, rotation around the Y axis is pitch, and rotation around the Z axis is yaw. The sensor 81 has this orthogonal coordinate system and is capable of detecting rotation angles around the X, Y, and Z axes, that is, roll angle, pitch angle, and yaw angle.

FIG. 4A illustrates an example of a multicopter 10 hovering while receiving wind from the left side of the figure and rotating clockwise by angle θ around the X axis (roll axis). The sensor 81 detects the first tilt angle θ of the multicopter 10 with respect to the first direction D1, as shown in FIG. 4A. The first tilt angle θ is represented by the angle between the first direction D1 and the Y axis (pitch axis). In other words, the first tilt angle θ is defined by the roll angle of the multicopter 10.

FIG. 4B illustrates an example of a multicopter 10 hovering while receiving wind from the left side of the figure and rotating clockwise by angle Ψ around the Y axis (pitch axis). The sensor 81 detects the second tilt angle Ψ of the multicopter 10 with respect to the second direction D2, as shown in FIG. 4B. The second tilt angle Ψ is represented by the angle between the second direction D2 and the X axis (roll axis). In other words, the second tilt angle Ψ is defined by the pitch angle of the multicopter 10.

When the wind force received by the multicopter 10 and the horizontal component of the thrust of the multicopter 10 (the sum of the thrust generated by each rotating rotor 2) are in balance, the multicopter 10 can stop in the air, that is, hover. As the wind force increases, the multicopter 10 tilts more to increase the horizontal component of thrust. In this way, the forces in the horizontal direction are balanced. Furthermore, by increasing the thrust, the weight of the multicopter 10 and the vertical component of the thrust are balanced, thereby maintaining the hovering state of the multicopter 10. Such control is achieved by PID control performed by a flight controller such as a flight controller. Note that the wind force is unknown to the flight controller, and the flight controller does not perform control that takes wind force into account. The flight controller is configured or programmed to control the multicopter 10 to remain stationary at its current position based on longitude, latitude, and altitude information included in the position information obtained by, for example, a GNSS receiver.

An example of the processor 82 may include one or more semiconductor integrated circuits, also referred to as a central processing unit (CPU) or microprocessor. The processor sequentially executes computer programs stored in storage 83 to implement the processes described later. The term processor is broadly interpreted to encompass devices such as FPGA (Field Programmable Gate Array) with CPU, GPU (Graphic Processor Unit), ASIC (Application Specific Integrated Circuit), or ASSP (Application Specific Standard Product).

The processor 82 estimates at least one of wind speed and wind direction based on sensor data output from the sensor 81 indicating the first and second tilt angles θ, Ψ. In example embodiments of the present disclosure, the processor 82 estimates at least one of wind speed and wind direction by referring to a table (lookup table: LUT) from the first and second tilt angles θ, Ψ detected by the sensor 81.

As mentioned earlier, the wind force is unknown to the flight controller. However, there is a one-to-one relationship between the wind speed (or wind force) and the first and second tilt angles θ, Ψ detected by the sensor 81. Therefore, if the first and second tilt angles θ, Ψ are determined, the wind speed can be estimated from these angles. Furthermore, as a result, the multicopter 10 eventually tilts toward the windward side, so the processor 82 can determine the wind direction from the direction in which the multicopter 10 tilts. For example, the processor 82 can estimate the wind direction from the attitude represented by the roll angle, pitch angle, and yaw angle detected by the sensor 81. In other words, the processor 82 can estimate the wind direction from the first tilt angle θ, the second tilt angle Ψ, and the yaw angle.

Some of the functions of the processor 82 may be implemented in the companion computer mentioned earlier. Alternatively, the companion computer may function as the processor 82. In this case, the companion computer estimates at least one of wind speed and wind direction based on sensor data output from the sensor 81 indicating the first and second tilt angles θ, Ψ. Furthermore, an external computer (for example, a server device) may function as the processor 82.

The multicopters according to example embodiments of the present disclosure may further include a storage 83 that stores a table, as shown in FIG. 3. The storage 83 may store a table that defines the relationship between the first tilt angle θ, the second tilt angle Ψ, and at least one of wind speed and wind direction.

The storage 83 is, for example, a writable memory (e.g., PROM), a rewritable memory (e.g., flash memory), or a read-only memory (ROM). The storage 83 may store a program that controls the operation of the processor 82. The storage 83 need not be a single recording medium but may be a collection of multiple recording media. Some portions of the collection may be removable memory.

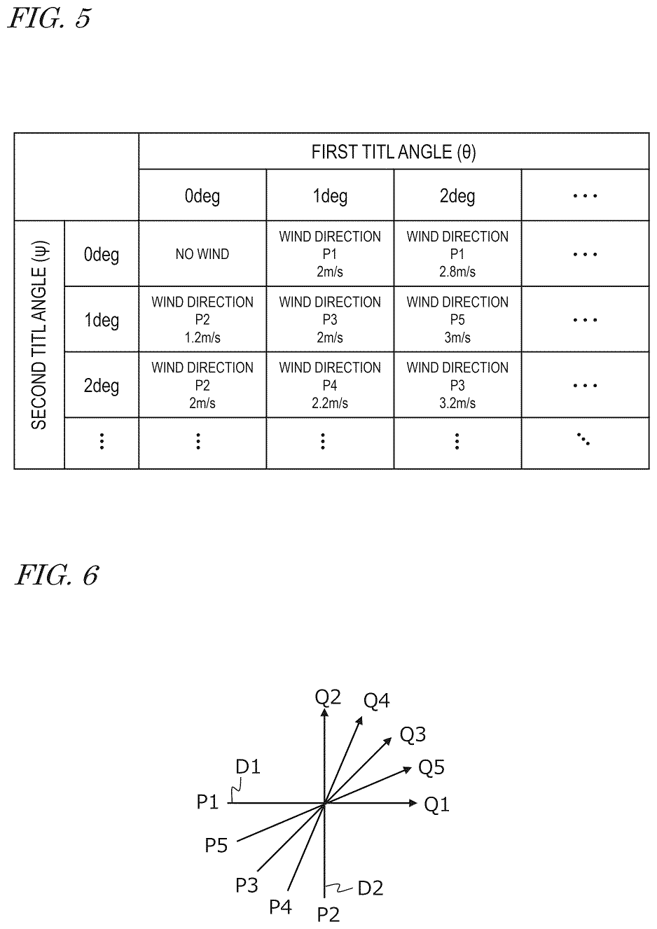

FIG. 5 is a diagram showing an example of a table. FIG. 6 is a diagram for explaining wind directions. The table exemplified in FIG. 5 defines the correspondence relationship between the first tilt angle θ, the second tilt angle Ψ, and wind speed and wind direction. This table may vary depending on the type of multicopter. More specifically, this table may vary depending on the shape and size of the multicopter's body. In this way, the storage 83 stores a table corresponding to the shape and size of the multicopter's body, that is, a table corresponding to the shape and size of its own body.

If the shape and size of the multicopter's body are known, it is possible to estimate wind speed from wind force. The relationship between wind speed and wind force depends on which direction the wind hits the body of the multicopter. For example, the wind force received by the body varies at the front, rear, left, and right sides of the body, which may each have different sizes, depending on the wind direction. The relationship between wind speed and wind force can be obtained by conducting experiments or simulations where wind of different speeds is applied to the multicopter from various directions in a wind tunnel, and the wind force is measured. The table may be determined based on experimental or simulation results.

When the communication device 4c receives a signal requesting wind speed, etc., from a controller or the like that operates the multicopter, the processor 82 may transition to a mode to estimate at least one of wind speed and wind direction (estimation mode). When the processor 82 transitions to the estimation mode, it may transition to automatic hovering control instead of executing flight control according to operation signals from the controller. When the processor 82 transitions to hovering control in the estimation mode, it estimates wind speed, etc., by referring to the first tilt angle θ, the second tilt angle Ψ, and the table shown in FIG. 5 during hovering. The release of the estimation mode, that is, the transition from the estimation mode to the normal flight mode, may be executed when the communication device 4c receives a release signal transmitted from the controller, or the estimation mode may be automatically released after a predetermined time has elapsed since the start of the estimation mode.

According to the example of the table shown in FIG. 5, the processor 82 estimates that there is no wind at the measurement spot if both the first tilt angle θ and the second tilt angle Ψ are zero.

The processor 82 estimates the wind speed to be 2 m/s if the second tilt angle Ψ is zero and the first tilt angle θ is 1°. The processor 82 estimates the wind speed to be 2.8 m/s if the second tilt angle Ψ is zero and the first tilt angle θ is 2°. The processor 82 further estimates that the wind is blowing from the starting point P1 toward the endpoint Q1 as shown by the arrow in FIG. 6. This wind direction is called wind direction P1. The wind direction P1 corresponds to the direction of the arrow indicating the first direction D1, for example, wind blowing from the west.

The processor 82 estimates the wind speed to be 1.2 m/s if the first tilt angle θ is zero and the second tilt angle Ψ is 1°. The processor 82 estimates the wind speed to be 2 m/s if the first tilt angle θ is zero and the second tilt angle Ψ is 2°. The processor 82 further estimates that the wind is blowing from the starting point P2 toward the endpoint Q2 as shown by the arrow in FIG. 6. This wind direction is called wind direction P2. The wind direction P2 corresponds to the direction of the arrow indicating the second direction D2, for example, wind blowing from the south.

The processor 82 estimates the wind speed to be 2 m/s if the first tilt angle θ is 1° and the second tilt angle Ψ is 1°. The processor 82 estimates the wind speed to be 3.2 m/s if the first tilt angle θ is 2° and the second tilt angle Ψ is 2°. The processor 82 further estimates that the wind is blowing from the starting point P3 toward the endpoint Q3 as shown by the arrow in FIG. 6. This wind direction is called wind direction P3. The wind direction P3 is, for example, wind blowing from the southwest.

The processor 82 estimates the wind speed to be 2.2 m/s if the first tilt angle θ is 1° and the second tilt angle Ψ is 2°. The processor 82 further estimates that the wind is blowing from the starting point P4 toward the endpoint Q4 as shown by the arrow in FIG. 6. This wind direction is called wind direction P4. The wind direction P4 is, for example, wind blowing from the south-southwest.

The processor 82 estimates the wind speed to be 3 m/s if the first tilt angle θ is 2° and the second tilt angle Ψ is 1°. The processor 82 further estimates that the wind is blowing from the starting point P5 toward the endpoint Q5 as shown by the arrow in FIG. 6. This wind direction is called wind direction P5. The wind direction P5 is, for example, wind blowing from the west-southwest.

In the present example embodiment described above, the processor 82 transitions to the estimation mode triggered as a result of the communication device 4c receiving a signal requesting wind speed, etc., from a controller. However, as an alternative, the processor 82 may automatically transition to the estimation mode when the operation signal from the controller indicates to execute hovering.

The wind speed and wind direction estimated by the multicopter may be transmitted from the communication device 4c to a controller, a mobile terminal, server, etc., and may be displayed on the monitor of the controller, the monitor of the mobile terminal, the monitor of a computer accessing the server, etc.

Thus, according to the multicopters of example embodiments of the present disclosure, even in locations where no anemometer is installed on the ground, wind speed and wind direction can be appropriately estimated at a measurement spot in the air, thereby enabling the acquisition of meteorological data such as wind speed and wind direction at more measurement spots. This makes it possible to perform detailed flight control of the multicopter considering wind speed and wind direction, enabling safe flight of the multicopter.

When wind speed exceeds a limit value, the flight of the multicopter must be restricted. By estimating the wind speed in the air at the measurement spot, if the estimated wind speed exceeds the limit value, or if the sum of the wind speed and the movement speed of the multicopter due to a tailwind exceeds the limit value, the processor may send a command to the controller to make the multicopter perform operations such as descending in altitude or landing. This can improve safety in emergency situations.

In example embodiments of the present disclosure, a combination of an IMU and a processor may be configured or programmed to function as an anemometer instead of a conventional anemometer. By mounting, for example, a thermometer, barometer, and hygrometer on the multicopter, it becomes possible to collect data useful for weather forecasting, such as wind speed, wind direction, atmospheric pressure, temperature, and humidity. In other words, a multicopter including an anemometer, a barometer, a thermometer, and a hygrometer is provided.

The multicopters according to example embodiments of the present disclosure may further include a connector to suspend an object.

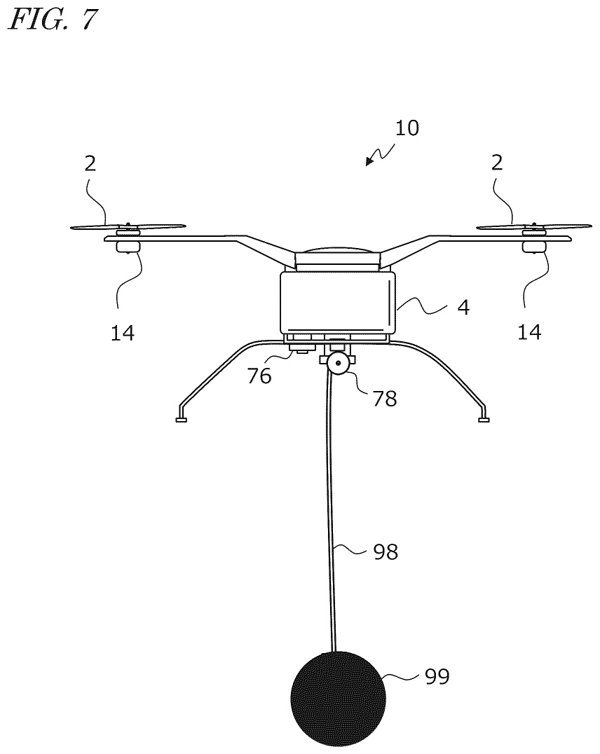

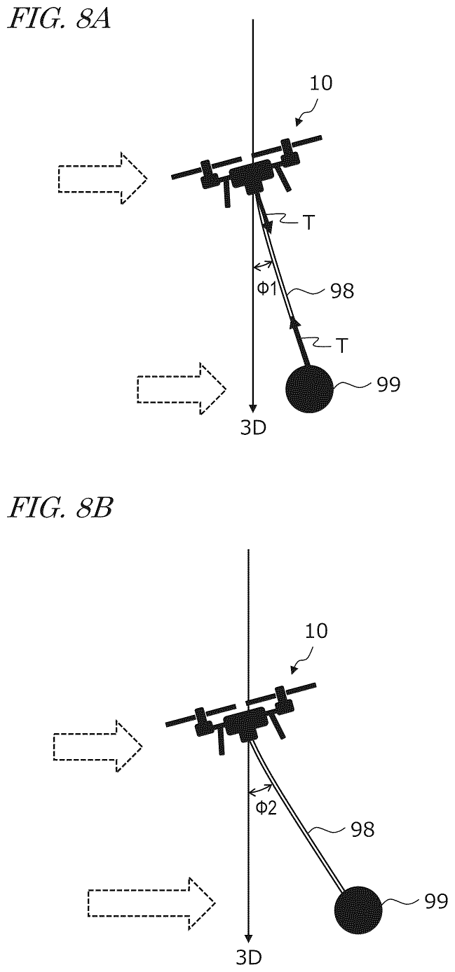

FIG. 7 is a side view schematically showing one example of a basic configuration of a multicopter 10 including a connector 78. FIGS. 8A and 8B are schematic diagrams showing the multicopter 10 hovering in the air with an object 99 suspended from it.

The multicopter 10 exemplified in FIG. 7 includes a connector 78 to suspend an object 99 via a working rope 98. The connector 78 enables winding and unwinding of the working rope 98. The connector 78 makes it possible to adjust the length of the working rope 98.

The processor 82 may estimate the wind speed around the object 99 according to the movement of the object 99 as it receives wind force when the multicopter 10 is in the air with the object 99 suspended from the connector 78. For example, the processor 82 obtains a third tilt angle φ when the multicopter 10 is in the air with the object 99 suspended from the connector 78, and estimates the wind speed around the object 99 based on the third tilt angle φ. The third tilt angle φ is the tilt angle of the working rope 98 (or object 99) with respect to the vertical direction (third direction D3), as shown in FIG. 8A or FIG. 8B.

Wind speed and wind direction near the ground may differ from wind speed and wind direction in the air. By suspending an object 99 from the multicopter 10, it becomes possible to estimate not only wind speed and wind direction in the air but also wind speed and wind direction near the ground.

In the example shown in FIG. 8A, the wind force received by the object 99 i relatively small, and in the example shown in FIG. 8B, the wind force received by the object 99 is relatively large. In this case, the third tilt angle φ1 shown in FIG. 8A is smaller than the third tilt angle φ2 shown in FIG. 8B. The horizontal component of the tension T shown in FIG. 8A is balanced with the wind force received by the object 99. Therefore, if the third tilt angle φ and the tension T are determined, it is possible to estimate the wind speed around the object 99 from them. For example, the multicopter 10 may include a measuring instrument for measuring the tension T. An example of the measuring instrument is a spring scale. An acceleration sensor to measure the third tilt angle φ and a communication device may be provided on the object 99. The communication device 4c of the multicopter 10 can communicate with this communication device, for example, via a network, and the processor 82 can obtain sensor data indicating the third tilt angle φ output from the acceleration sensor. The processor 82 can estimate the wind speed around the object 99 based on the third tilt angle φ and the tension T.

The table mentioned earlier may further define the relationship between the first tilt angle θ, the second tilt angle Ψ, the third tilt angle φ, the wind speed around the multicopter, and the wind speed around the object. The relationship between the first tilt angle θ, the second tilt angle Ψ, and the wind speed around the multicopter is as described with reference to FIG. 5. That is, the processor 82 can estimate the wind speed around the multicopter by referring to the table as shown in FIG. 5 from the first tilt angle θ and the second tilt angle Ψ.

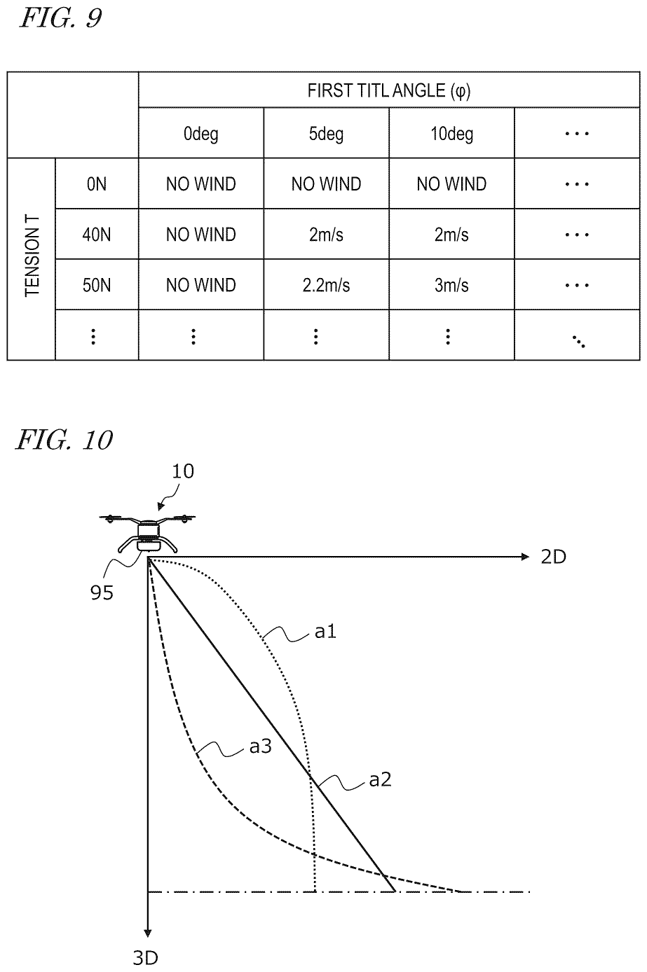

FIG. 9 is a diagram showing an example of a table defining the relationship between the third tilt angle φ, tension T, and wind speed around the object. The processor 82 may estimate the wind speed around the object by referring to the table from the third tilt angle φ and the tension T. This table may vary depending on the shape and size of the object 99. The relationship between wind speed and wind force can be determined from experiments or simulations as described earlier.

The multicopters according to example embodiments of the present disclosure may further include an applicator 95 (see FIG. 10) for applying, onto the ground, agricultural materials (hereinafter simply referred to as “materials”) in granular or liquid form. Examples of materials include liquid agents or granular agents such as herbicides or insecticides, water, and seeds. The processor 82 can determine the wind speed around the multicopter (or in the air) and the wind speed around the object (or near the ground) from the first tilt angle θ, the second tilt angle Ψ, and the third tilt angle φ by referring to tables exemplified in FIGS. 5 and 9. The processor 82 may further estimate the agricultural material application status from the determined wind speed in the air and the wind speed near the ground.

The object 99 may be a balloon formed from rubber, polymer resin, or fiber, containing gas inside, for example. The multicopters according to example embodiments of the present disclosure may include a storage compartment for storing a deflated balloon. To avoid interfering with the distribution of materials, for example, after the connector winds up the working rope, gas may be released from the balloon to deflate it, and the deflated balloon may be stored in the storage compartment. Alternatively, the spreader may be mounted on a separate multicopter from the one measuring wind speed and direction, and the two multicopters may work together to perform spreading operations.

The object 99 itself may be a applicator. For example, while the multicopter 10 ascends vertically to reach the altitude to start dispersing, the processor 82 may estimate the wind speed around the spreader at more measurement spots at different altitudes. Since data on wind speed can be obtained over a wide range from near the ground to high points in the air, the accuracy of estimating the agricultural material application status can be improved by utilizing the data obtained in this way.

FIG. 10 is a schematic diagram showing how the horizontal distance over which materials dispersed from the applicator 95 are scattered changes according to wind speed. In FIG. 10, the horizontal axis represents the horizontal distance from the multicopter 10, and the vertical axis represents the vertical distance from the multicopter 10. The chain line indicates the ground.

The dotted line a1 in FIG. 10 shows an example of a predicted agricultural material application status A1 when the wind speed in the air is relatively high and the wind speed near the ground is relatively low. The solid line a2 in FIG. 10 shows an example of a predicted agricultural material application status A2 when the wind speed in the air and the wind speed near the ground are equal. The dashed line a3 in FIG. 10 shows an example of a predicted agricultural material application status A3 when the wind speed in the air is relatively low and the wind speed near the ground is relatively high. Of course, the agricultural material application status varies depending on the type of material and may also vary depending on the weight and shape of the material.

Comparing the reaching distance of materials in the horizontal direction on the ground in the example shown in FIG. 10, the scattering distance in the agricultural material application status A3 is the largest, and the scattering distance in the agricultural material application status A1 is the smallest. In this way, the processor 82 can estimate the agricultural material application status from the wind speed in the air and the wind speed near the ground. Additionally, in dispersing operations, the dispersing direction of materials can be adjusted in real-time by controlling, for example, the angle of the nozzle that the applicator 95 has, based on the estimated wind speed and wind direction. This enables efficient dispersing operations.

Systems providing various functions in the example embodiments can also be attached later to multicopters that do not have those functions. Such systems may be manufactured and sold independently of the multicopter. Computer programs used in such systems may also be manufactured and sold independently of the multicopter. Computer programs may be provided, for example, stored on a non-transitory computer-readable storage medium. Computer programs may also be provided through downloads via telecommunications lines (e.g., the Internet).

In the example embodiments described above, wind speed and/or wind direction are estimated during hovering, but the multicopter 10 may estimate wind speed and/or wind direction not only during hovering but also during flight. A flying multicopter receives air resistance from the front in the direction of travel. As a result, under the same wind speed and wind direction conditions, the attitude of a flying multicopter differs from the attitude of a multicopter in a windless state. During flight of the multicopter, the flight controller controls the attitude of the multicopter so that the horizontal component of thrust is balanced with the combined force of the horizontal component of wind force and the horizontal component of air resistance. It is preferable for the processor 82 to correct the wind speed estimated by referring to a table according to the flight speed during flight of the multicopter 10. Similar to the relationship between wind speed and wind force, the relationship between flight speed and air resistance can also be determined from experiments or simulations. For example, a table associating flight speed with correction coefficients may be determined based on experimental or simulation results. The processor 82 may correct the estimated wind speed by referring to this table. This enables appropriate estimation of wind speed and/or wind direction at the measurement spot even when the multicopter 10 is flying.

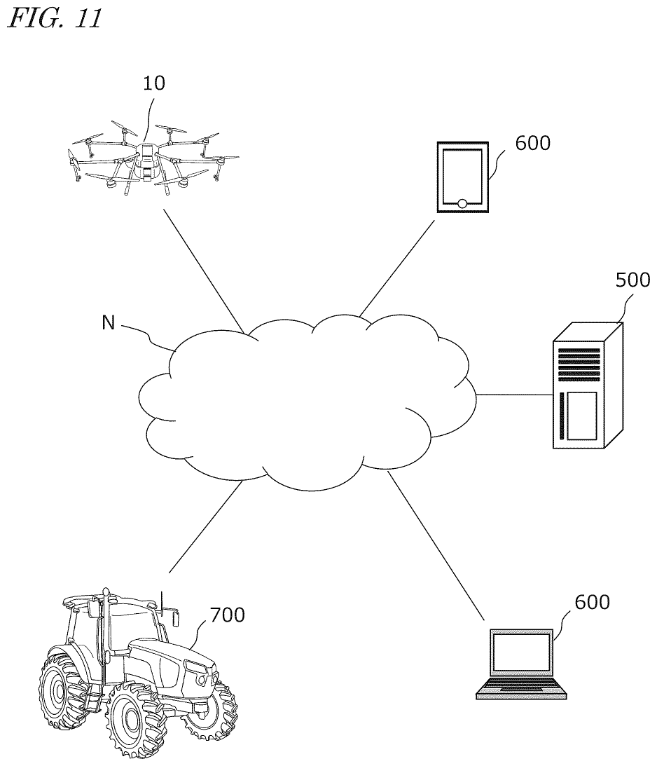

As mentioned earlier, the controller 4a may be configured or programmed to include, for example, a flight controller such as a flight controller and a higher-level computer (companion computer). The companion computer may execute the various processes necessary for estimating wind speed and wind direction, and provide flight-related commands based on the results of those processes to the flight controller or wind detection system. Additionally, as shown in FIG. 11, some or all of the functions of electronic equipment such as the controller 4a or the wind detection system mounted on the multicopter 10 may be implemented by one or more servers (computers) 500 or terminal devices (including portable and fixed types) 600 connected to the communication device 4c of the multicopter 10 via a communication network N. An agricultural machine 700 such as a tractor may be connected to this communication network N, and communication may be performed between the multicopter 10 and the agricultural machine 700. Through the communication network N, a portion of the data used for processing by the controller 4a and control signals for the multicopter 10 may be provided to the multicopter 10 from the agricultural machine 700.

Unmanned aerial vehicles according to example embodiments of the present disclosure may be widely utilized not only for aerial photography, surveying, logistics, and agricultural spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A wind detection system for use in an unmanned aerial vehicle, the wind detection system comprising:
a sensor to detect a first tilt angle of the unmanned aerial vehicle with respect to a first direction perpendicular to a vertical direction, and a second tilt angle of the unmanned aerial vehicle with respect to a second direction that is perpendicular to the vertical direction and intersects the first direction; and
a processor configured to estimate at least one of wind speed and wind direction based on sensor data output from the sensor indicating the first and second tilt angles.

2. The wind detection system according to claim 1, further comprising:
a storage to store a table defining a relationship between the first tilt angle, the second tilt angle, and at least one of the wind speed and the wind direction;
the processor is configured or programmed to estimate at least one of the wind speed and the wind direction from the first and second tilt angles detected by the sensor by referring to the table.

3. The wind detection system according to claim 2, wherein the storage stores the table that varies depending on a shape and a size of a body of the unmanned aerial vehicle.

4. The wind detection system according to claim 2, wherein the processor is configured or programmed to correct the wind speed estimated by referring to the table according to a flight speed during flight of the unmanned aerial vehicle.

5. The wind detection system according to claim 1, further comprising:
a connector to suspend an object via a working rope; wherein
the processor is configured or programmed to estimate the wind speed around the object according to movement of the object as the object receives wind force when the unmanned aerial vehicle is in the air with the object suspended from the connector.

6. The wind detection system according to claim 5, wherein the processor is configured or programmed to obtain a third tilt angle of the object with respect to the vertical direction when the unmanned aerial vehicle is in the air with the object suspended from the connector, and estimate the wind speed around the object based on the third tilt angle.

7. The wind detection system according to claim 6, wherein the storage stores the table that defines a relationship between the first tilt angle, the second tilt angle, the third tilt angle, the wind speed around the unmanned aerial vehicle, and the wind speed around the object.

8. The wind detection system according to claim 7, further comprising:
a spreader to disperse granular or liquid agricultural materials on a ground; wherein
the processor is configured or programmed to:
determine the wind speed around the unmanned aerial vehicle and the wind speed around the object from the first tilt angle, the second tilt angle, and the third tilt angle by referring to the table; and
estimate an agricultural material application status of the agricultural materials from the determined wind speed around the unmanned aerial vehicle and the wind speed around the object.

9. The wind detection system according to claim 1, wherein the first tilt angle is defined by a roll angle of the unmanned aerial vehicle, and the second tilt angle is defined by a pitch angle of the unmanned aerial vehicle.

10. An unmanned aerial vehicle comprising:
a plurality of rotors; and
the wind detection system according to claim 1.
